(19) United States
(12) Patent Application Publication
(10) Pub. No.: US 2005/0026128 A1
(43) Pub. Date: Feb. 3, 2005

(54) Print media apparatus for young children

(75) Inventors: Michael C. Wood, Orinda, CA (US); Jason Avery, Berkeley, CA (US); Larry Lynch, Las Gatos, CA (US); Michael Perkins, Santa Clara, CA (US); John Caldwell, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA (US)

(21) Appl. No.: 10/781,554

(22) Filed: Feb. 17, 2004

Related U.S. Application Data
(60) Provisional application No. 60/448,782, filed on Feb. 18, 2003.
(60) Provisional application No. 60/486,392, filed on Jul. 10, 2003.

(51) Int. Cl. G09B 5/00

(52) U.S. Cl. 434/317

(57) ABSTRACT

A print media apparatus is disclosed. The print media apparatus includes a platform including a surface and a first coupling element. A plurality of electrical elements is under the surface. A processor is coupled to the plurality of electrical elements. A book is on the surface and has a spine having a second coupling element. The book and the platform are removably coupled through the first and second coupling elements.

### CROSS-REFERENCE TO RELATED APPLICATIONS

This patent application is a non-provisional of and claims the benefit of the filing dates of U.S. Provisional Patent Application No. 60/448,782, filed on Feb. 18, 2003, and U.S. Provisional Application No. 60/486,392, filed on Jul. 10, 2003. These U.S. Provisional Patent Applications are herein incorporated by reference in their entirety for all purposes.

### BACKGROUND OF THE INVENTION

A number of book reading apparatuses are known. One such apparatus that was produced in the 1980's was called the Teach Me Reader. In this product, a book is placed on a unit. Pressure switches are under the book. When a child depresses a word in the book, the child also depresses a pressure switch underneath the book. A speaker in the unit then sounds out the word. Depressing a symbol on a page in the book causes another switch underneath the symbol to activate. A speaker in the unit may then sound the words on the page.

While the Teach Me Reader is a useful product, there are a number of problems associated with it. First, young children such as infants and toddlers may want to readily turn the pages of the book, and may force the book off of the unit since the book is not secured to the unit. A parent or child needs to continually re-adjust and re-position the book on the unit. Older children do not tend to have this problem. Second, if a parent is using the unit to interact with a book with a child, the child may want to sit on the parent's lap. The Teach Me Reader unit has a hard plastic back that makes it uncomfortable and difficult to use when a young child is on the parent's lap. The unit may shift while it is on the parent's lap, thereby making it difficult to operate.

Also, the Teach Me Reader uses books with one interactive mode for one skill level. It does not have different skill or age levels for the same book. Thus, the functionality of the Teach Me Reader is limited. It would be desirable if a book reading device could include different skill or age levels so that the book reading device can be used as the child grows.

Embodiments of the invention address these and other problems.

### SUMMARY OF THE INVENTION

Embodiments of the invention are directed to print media apparatuses, methods of using print media apparatuses, and kits including books for use with print media apparatuses.

One embodiment of the invention is directed to a print media apparatus comprising: (a) a platform including a surface and a first coupling element; (b) a plurality of electrical elements under the surface; (c) a processor coupled to the plurality of electrical elements; and (d) a book on the surface, wherein the book comprises a spine having a second coupling element, wherein the book and the platform are removably coupled through the first and second coupling elements.

Another embodiment of the invention is directed to a print media apparatus comprising: (a) a platform including a surface; (b) a plurality of electrical elements under the surface; (c) a processor coupled to the plurality of electrical elements; and (d) a book on the surface, wherein the book comprises a mode selection print element, and wherein selecting the mode selection print element one time causes the apparatus to be in a first mode, selecting the mode selection print element a second time causes the apparatus to be in a second mode, and selecting the mode selection print element a third time causes the apparatus to be in a third mode.

Another embodiment of the invention is directed to a method of using a print media apparatus comprising: (a) providing a print media apparatus comprising (i) a platform including a surface and (ii) a book on the surface, wherein the book comprises a mode selection print element, and wherein selecting the mode selection print element one time causes the apparatus to be in a first mode, selecting the mode selection print element a second time causes the apparatus to be in a second mode, and selecting the mode selection print element a third time causes the apparatus to be in a third mode; and (b) selecting the mode selection print element one time to cause the apparatus to be in the first mode, two times to cause the apparatus to be in the second mode, or three times to cause the apparatus to be in the third mode.

Another embodiment of the invention is directed to a kit comprising: (a) a book comprising a spine and a plurality of pages comprising print elements, wherein the spine includes opposite ends comprising first coupling elements for coupling the book to a platform including corresponding second coupling elements; and (b) a removable memory device comprising code for sounds associated with the print elements.

Another embodiment of the invention is directed to a print media apparatus comprising: (a) a platform including a surface and a first coupling element; (b) a plurality of electrical elements under the surface; (c) a processor coupled to the plurality of electrical elements; (d) a book on the surface, wherein the book comprises a spine; (e) a first region of the surface proximate the spine of the book; and (f) a second region of the surface distal to the spine of the book, wherein the first region is more sensitive to user interaction than the second region.

These and other embodiments of the invention are described in further detail below.

### BRIEF DESCRIPTION OF THE DRAWINGS

FIG. 1 shows a plan view of a print media apparatus according to an embodiment of the invention.

FIG. 2 shows a plan view of the print media apparatus according to an embodiment of the invention.

FIG. 3 shows a protruding member that engages a portion of a spine of a book.

FIG. 4 shows a book according to an embodiment of the invention.

FIG. 5 shows a bottom perspective view of a print media apparatus according to an embodiment of the invention.

FIGS. 6-9 show exemplary electrical schematic drawings for electronics that can be used in embodiments of the invention.

These and other embodiments are described below in the Detailed Description with reference to the Figures.

### DETAILED DESCRIPTION OF THE INVENTION

Embodiments of the invention are directed to print media apparatuses, methods of using print media apparatuses, and kits including books for use with print media apparatuses.

Although older children can use embodiments of the invention, they are especially suitable for use by younger children. For example, 12 to 24 months of age is a period when word comprehension, word production, and grammar skills increase dramatically. In this period, children learn abstract ideas like shapes, numbers, and colors. Embodiments of the invention are well suited to teach such skills and concepts, and are well suited for pre-school age children.

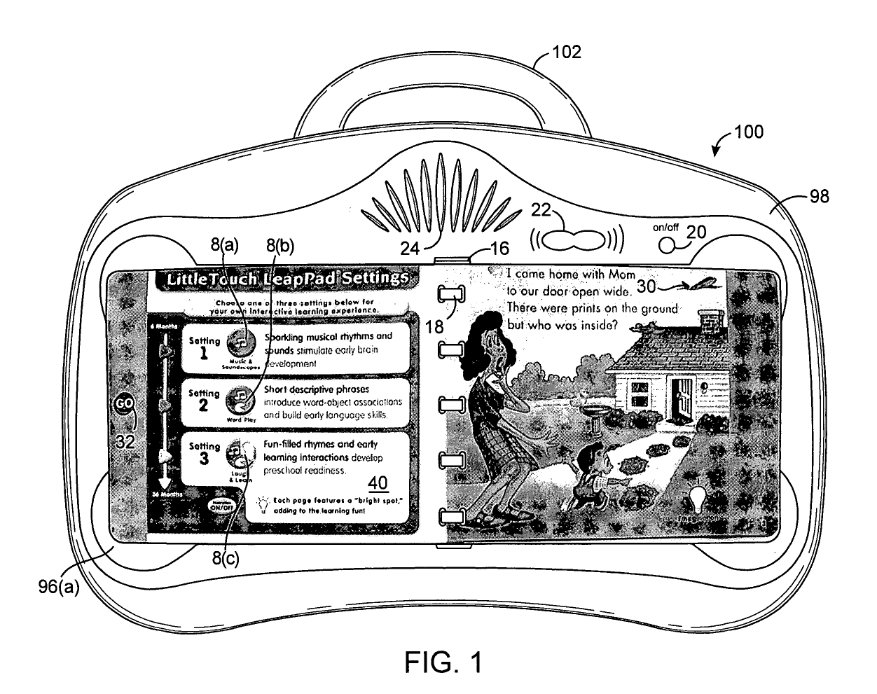

FIG. 1 shows a print media apparatus 100 according to an embodiment of the invention. The print media apparatus 100 includes a platform 98 that includes a surface, and a border region 96 defining the surface. A book 40 is on the surface and is at a first side of the platform 98. The second side of the platform 98 may be opposite to the first side of the platform 98. The border region 96 includes a number of finger wells 96(a) which allow a parent or child to grasp pages of the book 40 to turn them. The platform 98 also includes a volume control button 22, an on/off switch, and a speaker 24. A handle 102 is also attached to the platform 98 to allow a user to carry the apparatus 100. In some embodiments, an automatic shut-off feature may be pre-programmed into a processor in the apparatus 100.

Although a book is shown, other print media such as activity cards, or sheets can be used. The activity cards and sheets can have various print elements like the books that are explicitly described herein.

The pages of the book 40 may be made of any suitable material. In preferred embodiments, the pages of the book 40 comprise sheets of continuous high-density polyethylene fibers that are randomly distributed and non-directional. An exemplary material that has such characteristics is Tyvek™, which is commercially available from DuPont. Materials such as this are thin, flexible, and tear resistant. They are also thin and slippery and consequently allow more pages to be used (e.g., before the pages themselves activate switches).

The pages of the book 40 are bound with a ring type spine 18 that passes through the pages of the book 40. The opposite, longitudinal ends of the ring-type spine 18 include second coupling elements (not shown in FIG. 1). The second coupling elements can engage first coupling elements (not shown in FIG. 1) at coupling points at opposite edge regions 16 of the surface. The second coupling elements may be male-type coupling elements, while the first coupling elements may be female-type coupling elements (or vice-versa). In either case, the first and second coupling elements may engage each other and may removably couple the book 40 to the platform 98. When the book 40 is coupled to the platform 98, it does not fall out when the platform 98 is turned upside down.

A plurality of electrical elements (not shown) may be under the surface. In some embodiments, each electrical element is a pressure-sensitive switch that is activated by pressure. A suitable pressure-sensitive switch may comprise, for example, facing conductive regions that are separated by an air gap. Pressure applied to the conductive regions causes the facing conductive regions to contact each other closing the switch. Another type of electrical element may be a piezoelectric type element. The application of pressure to a piezoelectric type element causes it to change resistance. Pressure can be applied by, for example, a finger or a marking instrument such as a crayon that is above the electrical element. Some preferred pressure switches can be Mylar™ type switches that are disclosed in U.S. Pat. No. 6,608,618, which is herein incorporated by reference in its entirety.

The pressure sensitive switches may be formed by obtaining a first sheet including a first conductive material and a relatively flexible second sheet including a second conductive material. The relatively flexible second sheet may comprise a Mylar™ sheet that has conductive patterns printed on it. Dielectric dots or other spacers can be between the first and second sheets. These dielectric spacers may be printed on either the first sheet or the second sheet, or may be formed independently of the first and the second sheets. In some embodiments, the dielectric spacers may have different heights at different x-y locations to provide for variable sensitivity across a platform. For example, a first active region of a platform near the spine region of a book may have thinner spacers and a second active region near the edges of the pages of the book may have thicker spacers. As a result, the first active region may be more sensitive to activation or user interaction than the second active region. This is desirable, since it is often more difficult to press down on pages near the spine of a book to active switches underneath the book than it is to press down on pages near the edges of the pages of the book to active switches underneath the book. Accordingly, in such embodiments, the physical structures of the switches in the platform may provide for a variable sensitivity response in the x-y plane of a platform. In other embodiments, it is possible to program the electronics in the platform so that different electrical elements are provided with different levels of sensitivity to a user's interaction with a book on the platform.

Providing variable sensitivity across the surface of the platform has a number of advantages. For example, young children may not know that they need to press down harder in the region proximate the spine of a book to receive an output response from the platform than when pressing down in a region that is distal to the spine of the book. In the embodiments described above, the electronics in the platform are automatically adjusted so that the physical properties of the book and their effects on user interaction are automatically taken into account. While it may be possible to make the entire surface of the platform highly sensitive to the touch of a young child, this may cause the platform to activate when a child does not in fact intend to activate the platform.

In other embodiments, the electrical elements can be antennas such as those described in U.S. Pat. No. 5,877,458 or 5,686,705, and U.S. patent application Ser. No. 09/777,262 (now U.S. Pat. No. 6,668,156), Ser. No. 09/574,599 (now U.S. Pat. No. 6,661,405), and 60/200,725. All of these patents and patent applications are assigned to the same assignee as the present application and are incorporated herein by reference in their entirety for all purposes. The antennas can transmit signals that can be received by a stylus that is coupled to the platform. The stylus acts as a receiving antenna. When the stylus is positioned over the major surface, the stylus receives a signal that is particular for the electrical element underneath the stylus. Then, the position of the stylus relative to the major surface can be determined. The stylus could be used to interact with print elements on a sheet that is secured to the platform. The electrical elements may be transmitting antennas that regularly transmit signals that are received by the stylus, or may be receiving antennas that receive a signal from the stylus. In these embodiments, a user need not selectively activate the electrical elements.

The output provided to the user by the apparatus may be visual output and/or audio output. Audio output is preferred as audio output can supplement and reinforce visual information such as letters, pictures, and numbers that may be on the sheets. The combination of both audio output and visual output reinforces concepts that are taught by the apparatus.) Exemplary output can include letters, stories, numbers, words, phrases, jokes, music, questions, answers, prompts, sound effects, facts, etc. Preferably, the audio output is provided after the user presses a print element.

In some embodiments, the output can be a prompt that asks the user for a response. For example, an exemplary question that the apparatus might ask the user may be “Can you find the letter P?” In response, the user can press down on the letter P on a page. After the user responds, an output relating to the correctness or the incorrectness of the user's response can be provided to the user. For example, if the user's response is correct, a reward output (e.g., “that's right!”) can be provided to the user. If the response is incorrect, the question can be repeated or the user can be informed that the response was incorrect.

The output can have some relationship to the information conveyed by the print element or the nature of the print element. For instance, the output can relate to the identity, form, color, shape, or quality of a print element on a page. For example, after pressing a picture of a frog on page on the platform, the phrase “Hi, I'm Leap!” can be retrieved from memory and a speaker in the platform can sound the phrase to the user. Alternatively or additionally, the output can provide additional information about a particular print element. For example, a print element can be in the form of a bird. After the user interacts with the print element, information such as the type of bird depicted can be presented to the user.

Various other print elements can be provided in the book 40. For example, at the edge of the open pages of the book 40 is a “go” circle page indicator icon 32. A parent or child can depress this page indicator icon to inform the electronics in the platform 98 that a particular page or set of pages is open. For each set of displayed pages, the same or substantially the same page indicator icon would be located at a different point on the edges of the displayed pages so that the user can interact with a different electrical element for each set of displayed pages.

An automatic page detection system may also be used. In one embodiment, the pages may have reflectors or holes. Specific combinations of pages may form different patterns using the reflectors or holes, and the patterns may be used to activate an array of sensors in the platform to determine which page or pages are being displayed to the user. In another embodiment, each page may have a magnet embedded at a different location along the length of the spine of a book. An array of electromagnetic switches (e.g., reed switches) can be in the platform in the vicinity of the spine region of the book when the book is on the platform. When a page is turned, a specific combination of switches is activated, thus informing the electronics in the platform as to which page or pages are currently being displayed to the user. Other page detection systems can be used in other embodiments of the invention.

Mode selection print elements can also be present in the book 40. The left page in FIG. 1 shows three icons for three different modes including a first mode, a second mode, and a third mode. As shown on the left page, the three different modes can correspond to three different learning levels for three different ages of a child. In this example, the first mode provides sparkling musical rhythms and sounds when the user selects a first icon 8(a), and then the print element 30. For example, when print element 30 in the form of an airplane is pressed, a pressure switch under the airplane activates, and a microprocessor in the platform 98 retrieves code for an airplane sound from a memory device and plays the airplane sound through the speaker 24. The second mode provides a short descriptive phrase when the user selects the second icon 8(b) and then the print element 30. For example, in the second mode, after the user selects the print element 30, the phrase “zooming airplane” may sound from the speaker 24. The third mode provides a fun-filled rhyme and early learning interaction when the user selects the third icon 8(c) and then the same print element 30. For example, in the third mode, after the user selects the print element 30, the phrase “Flying, flying, through the air, I can fly most anywhere” can sound through the speaker 24. Thus, a single print element 30 may be depressed by the user to provide three different outputs associated with three different modes. As illustrated by the above example, the three different outputs are suitable for different ages to encourage learning as young children such as infants and toddlers rapidly progress in their intellectual ability, especially during the ages of 6 months to 36 months.

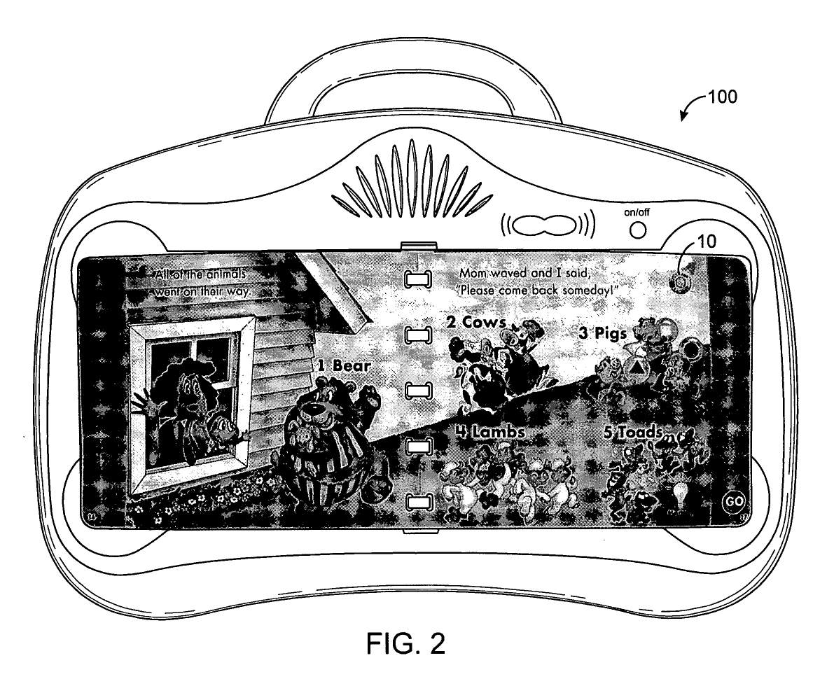

FIG. 2 illustrates another embodiment. In this example, instead of having 3 different icons 8(a), 8(b), 8(c) for selecting three different operational modes, a single mode selection print element 10 is provided on the page. Selecting the mode selection print element 10 one time causes the apparatus to be in the first mode (as described above), selecting the mode selection print element 10 a second time causes the apparatus to be in the second mode, and selecting the mode selection print element 10 a third time causes the apparatus to be in the third mode. The cycle may then repeat itself if the user selects the print element 10 a fourth, fifth, etc. time. Advantageously, a single mode selection print element 10 can be used by the user to change between 3 (or more) different modes for the apparatus. These functions (and any other functions described herein) can be pre-programmed as computer code into a memory device in or coupled to the platform 98. The use of a single mode selection icon not only saves space in the book 40, but also dispenses with the need to provide for physical mode selectors in the platform 98 itself. This reduces the bulkiness of the platform 98 as well as the cost of producing the platform 98.

Other print elements can be used (e.g., narration print elements). When a narration print element is selected, for example, all (or some) words on a page of the book 40 may sound. Game print elements can also be provided. When a game print element is selected, a game can be played with the apparatus. For example, a “can you find me?” game can start after an appropriate game icon is selected in a book. The user may then be asked to find a particular word or print element in the book by selecting it. The narration and game print elements may be in the form of an icon or symbol.

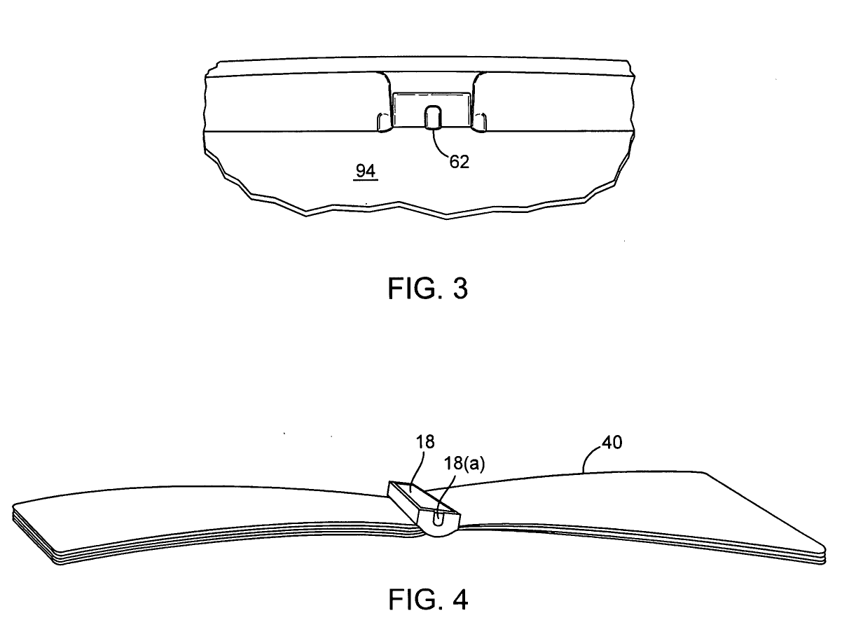

FIG. 3 shows a first coupling element 62 at an edge region of the surface 94 upon which the book rests. Referring to FIG. 4, the first coupling element 62 includes a protrusion 62, which engages a second coupling element 18(a) including a recess at an end of a spine 18 so that the book 40 and the platform 98 are removably coupled together. For example, the book 40 will not separate from the platform 98 is the platform 98 is turned over, since the book's spine 18 is coupled to the platform 98. However, if the user wants to remove the book 40, the user can pull on the book 40 or the spine 18 with a predetermined amount of force to uncouple the first and second coupling elements 18(a), 62 and to therefore separate the book 40 and the platform 98. Preferably, a child or parent can close the book 40 and then pull on the pages of the book 40 to separate it from the platform 98.

Other removable coupling mechanisms could also be used. For example, the middle or ends of the spine 40 could have snap button parts that snap into corresponding snap button parts in the platform 98. In another example, the platform 98 could have a clamp that clamps onto the spine of the book 40. Regardless of the type of mechanism used, to uncouple the book from the platform, one may use an amount of force that is greater than the amount of force needed to lift the book to uncouple the book from the platform.

Removably coupling the book 40 to the platform 98 has a number of advantages. As noted above, the print elements in the book 40 lie over electrical elements that in turn identify to a microprocessor which print elements were selected by the user so that specific outputs can be provided to the user. Since the book 40 is securely positioned on the surface of the platform 98, the user can be certain that the print elements in the book 40 will not become misaligned with the underlying electrical elements. Also, young children such as infants and toddlers cannot separate the book 40 from the platform 98 during normal use. Children frequently want to turn pages of a book. If there is an urge to do so, the child's manipulation of the book will not require a parent to continually insert the book into its proper position on the platform 98.

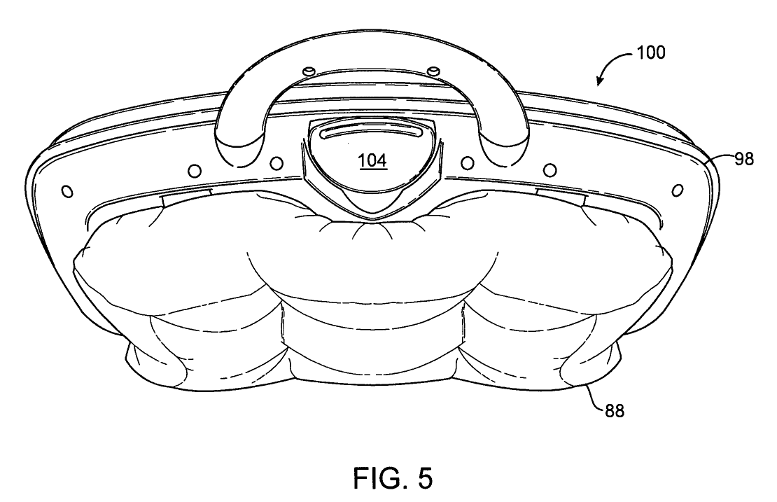

As shown in FIG. 5, the bottom of the apparatus 100 may optionally include a cushion 88 that is removably secured to the second side of the platform 98. In FIG. 5, a data cartridge 104 is shown and may fit within a cooperatively structured recess in the platform 98. The data cartridge 104 may contain code for audio associated with the book that is on the first side of the platform 98.

The cushion 88 provides a number of advantages. The embodiments shown in the preceding Figures are especially useful when a parent uses them with young children. The parent may operate the apparatus while reading or interacting with a young child. The young child may want to sit on the parent's lap and the cushion 88 provides more comfort to the parent as the parent holds both the apparatus and the child. The cushion 88 can rest on the parent's arm or leg, and conform to the shape thereof so that the platform 98 can remain level. Even if the platform 98 is tilted towards the parent, the book 40 does not fall out as it is removably coupled to the platform 98.

The above-described books and data cartridges may be present as kits. In one embodiment, the kit may include (a) a book comprising a spine and a plurality of pages comprising print elements, wherein the spine includes opposite ends comprising second coupling elements for coupling the book to a platform including corresponding first coupling elements, and a removable memory device comprising code for sounds associated with the print elements. The removable memory device is preferably a data cartridge, but may also be a CD-ROM, memory stick, or other removable memory device.

It is also possible to download new computer code to the apparatus or to a memory device, and then use the new downloaded code. The downloaded code can be from a server computer that is accessible through the Internet. Various downloading methods are described in, for example, U.S. patent application Ser. No. 09/886,401, now U.S. Pat. No. 6,608,618, which is herein incorporated by reference in its entirety for all purposes.

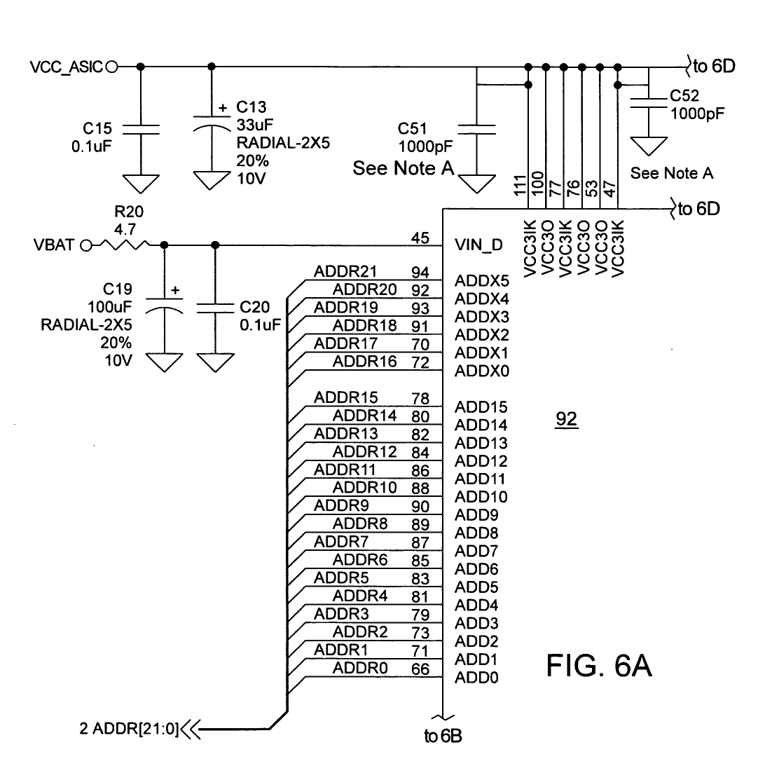

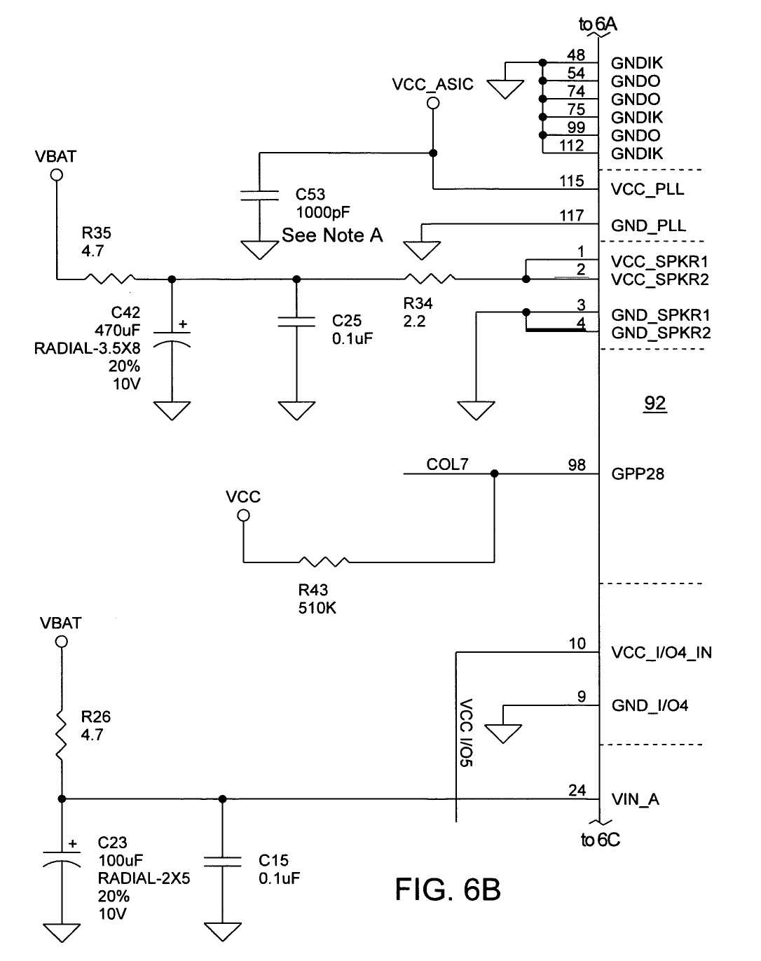

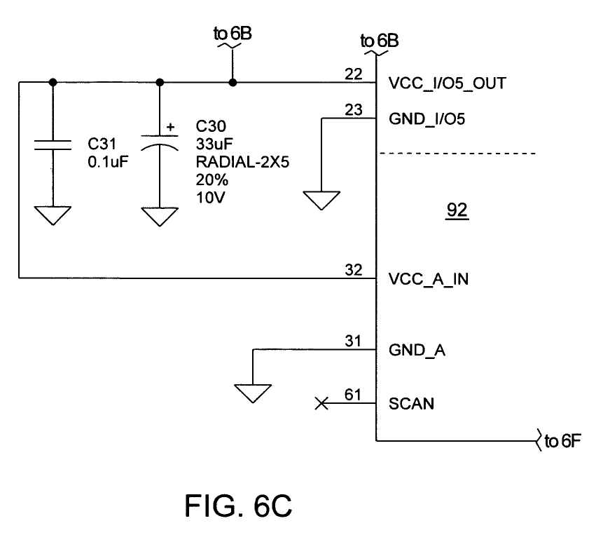

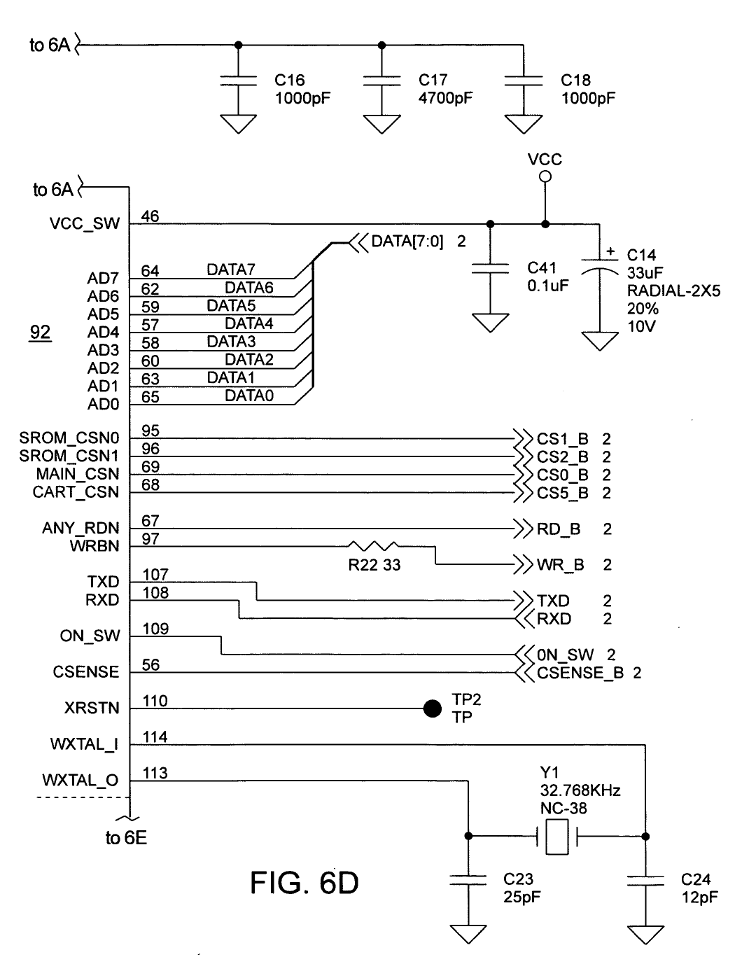

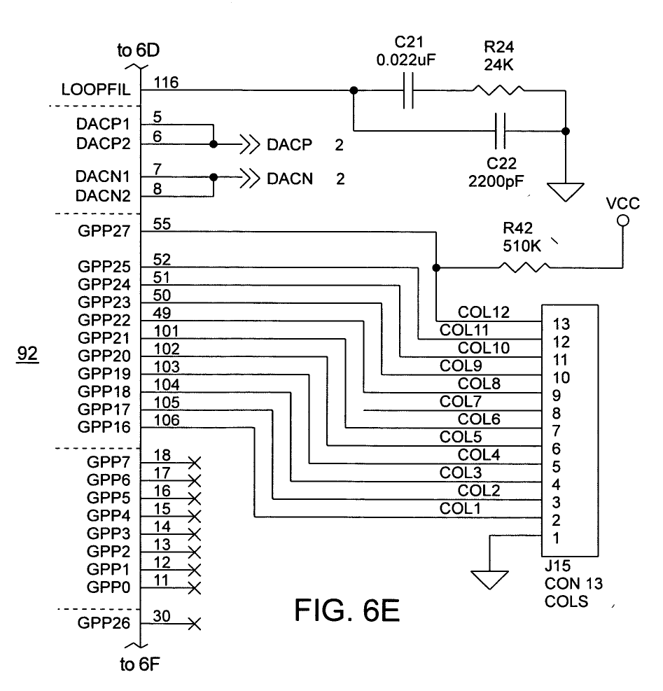

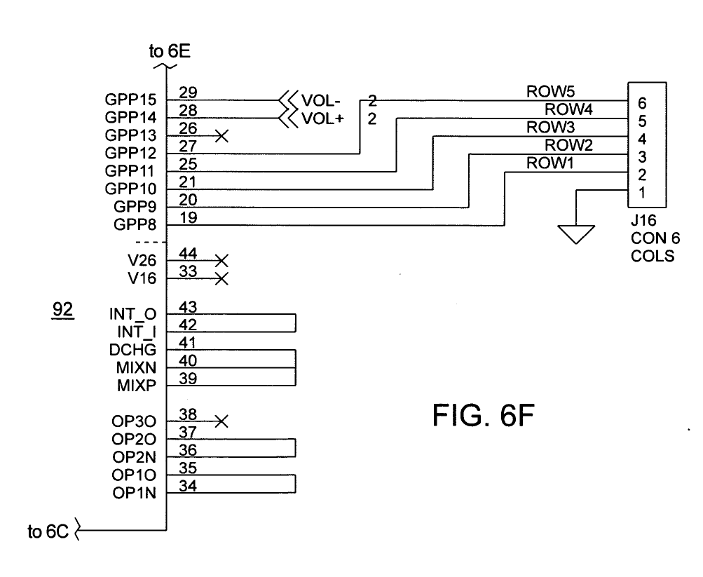

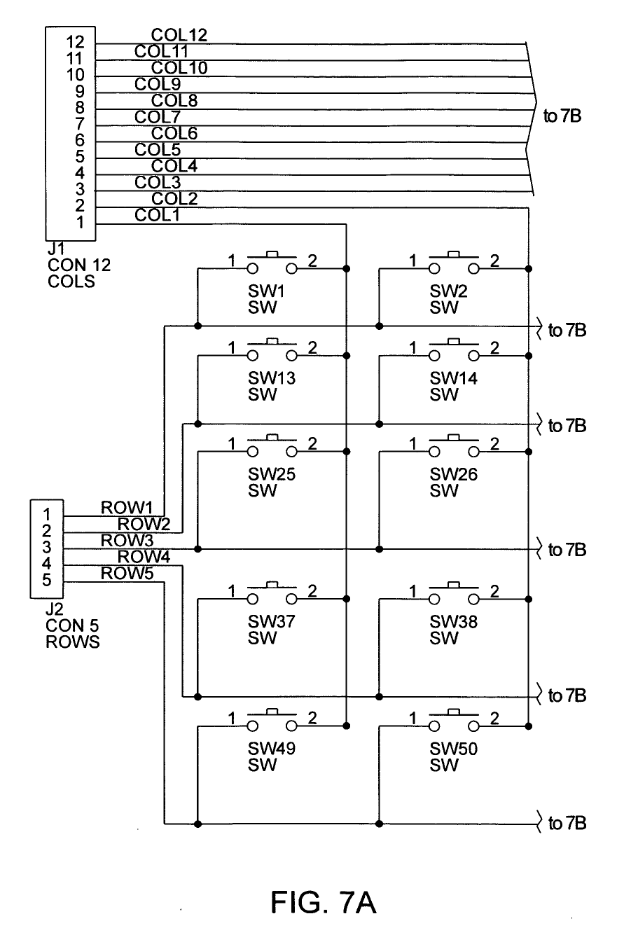

FIG. 6-9 show exemplary circuit diagrams of a circuit implementation that can be used in embodiments of the invention. It is understood that many other circuit implementations can be used and yet still arrive at embodiments of the invention.

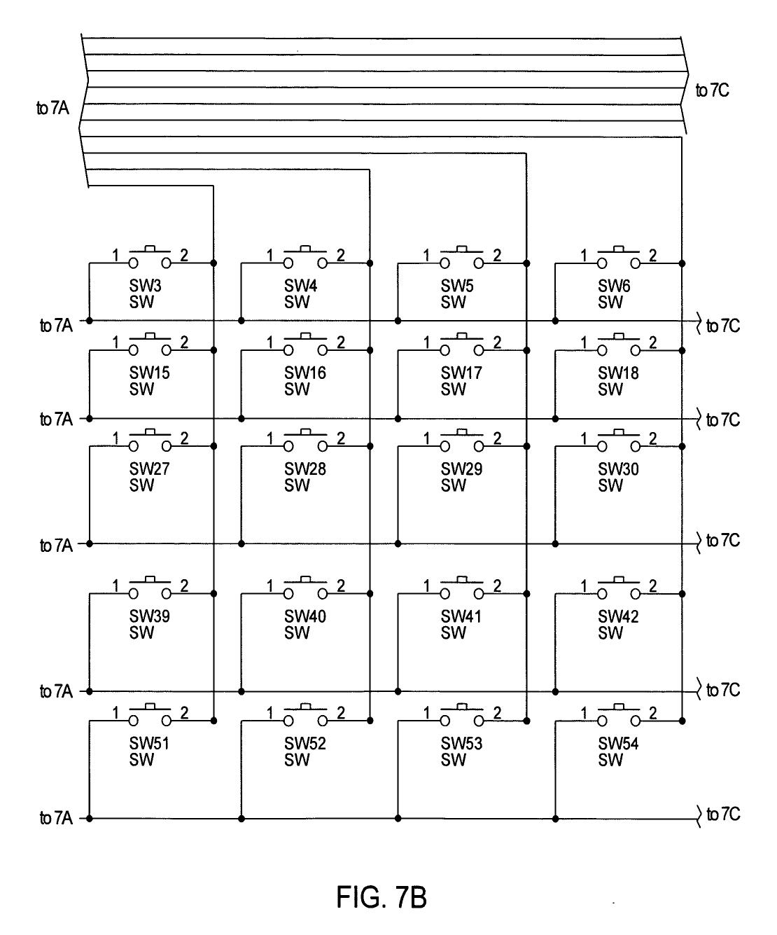

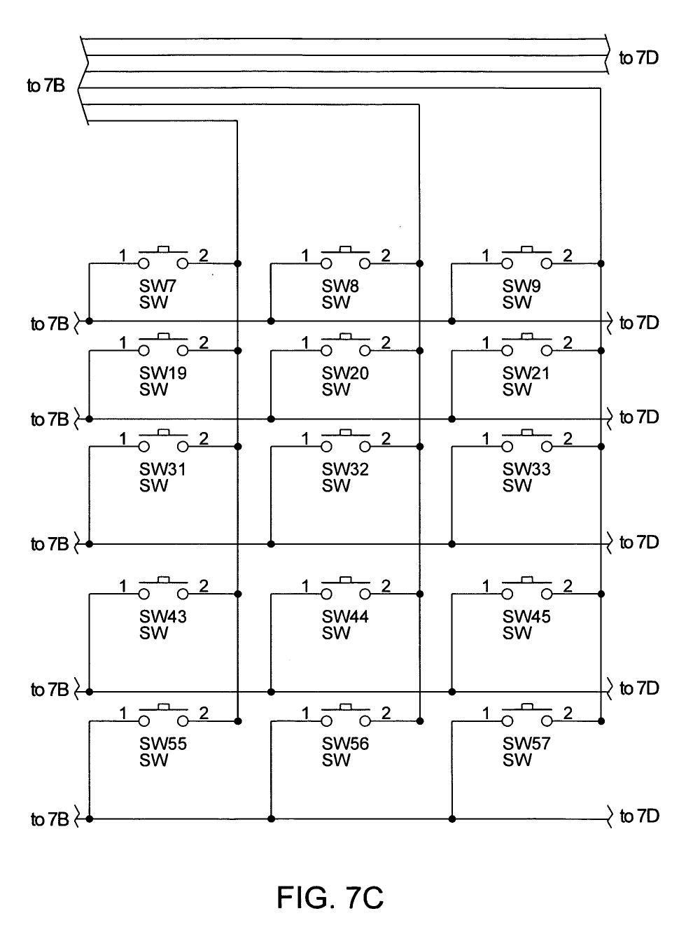

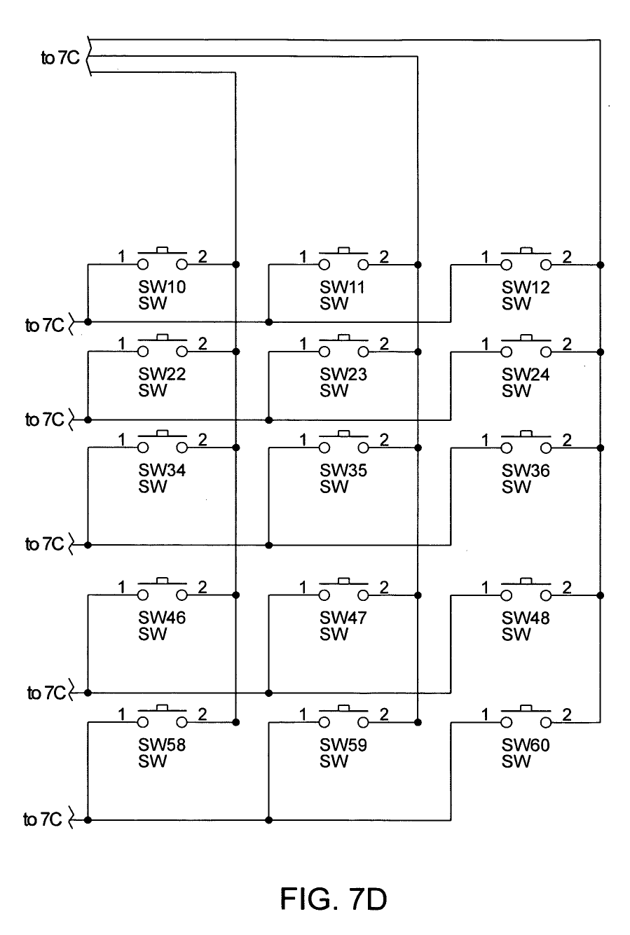

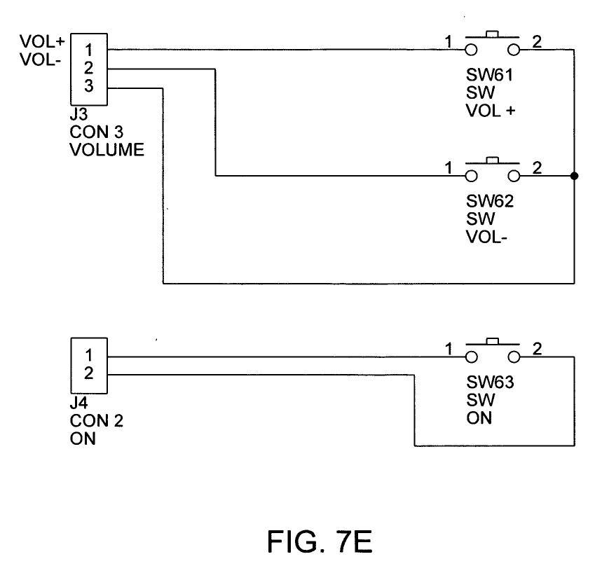

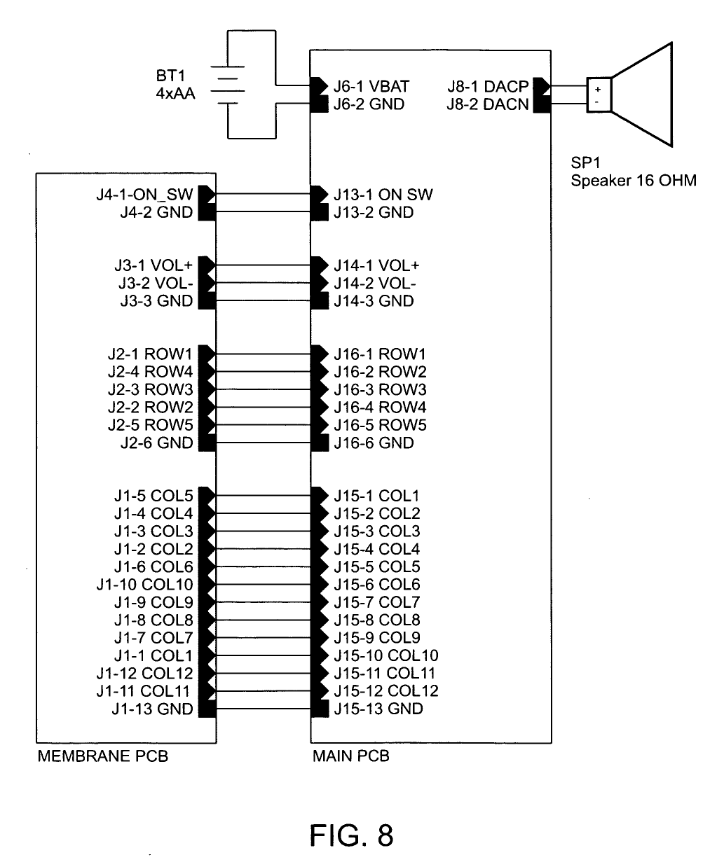

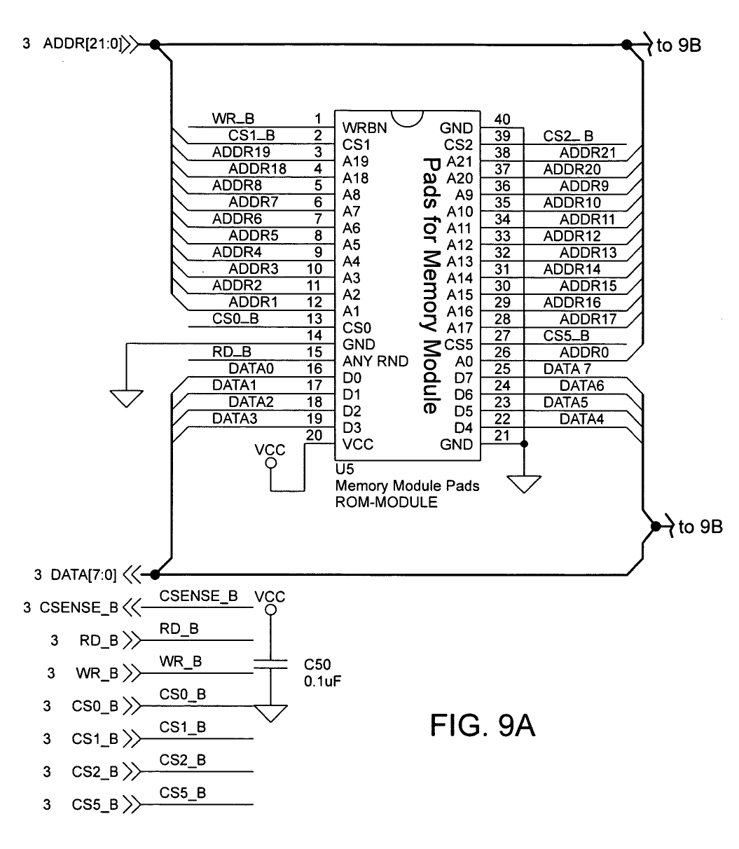

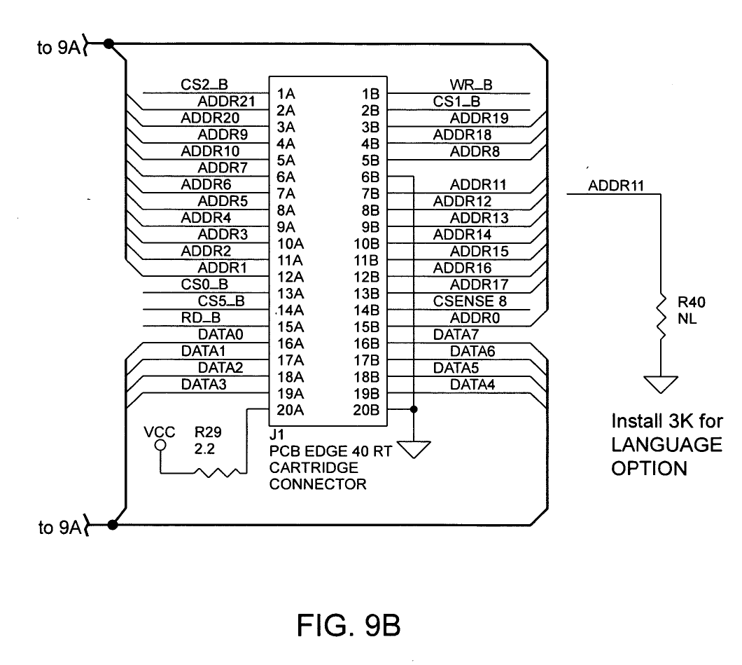

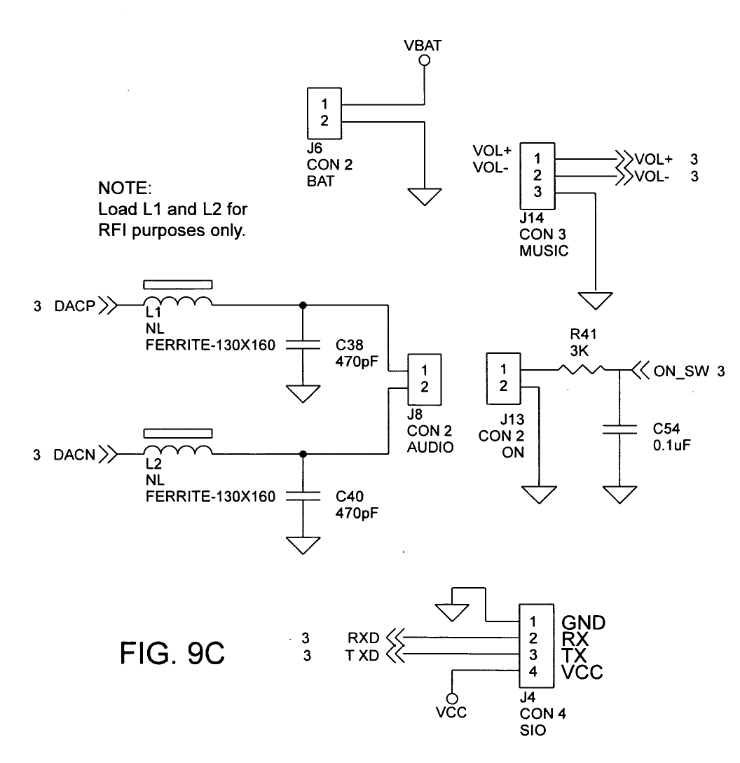

FIG. 6 shows a microprocessor 92 which is electrically coupled to the switch array, and the on/off and volume switches shown in FIG. 7. The microprocessor 92 may include or be coupled to a memory device that contains code for audio outputs, code or visual outputs, code for an operating system, etc. Many commercially available microprocessors including those commercially available from SunPlus Technologies may be used. The switch array could be under the surface of the platform upon which the book rests. FIG. 8 shows the electrical connections between a membrane PCB (printed circuit board) with the switch array and a main PCB. The main PC is coupled to a speaker and a battery. The speaker is electrically coupled to the microprocessor 92 shown in FIG. 6. FIG. 9 shows pads for a memory module and a PCB edge connector.

It is understood that any of the above described functions may be programmed into a memory device in or coupled to the above described apparatus by one of ordinary skill in the art, and that embodiments of the invention include apparatuses with memory devices that are preprogrammed to provide such functions.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

All references, patent applications, and patents mentioned above are herein incorporated by reference in their entirety for all purposes. None of them are admitted to be prior art to the presently claimed inventions.

1. A print media apparatus comprising:
(a) a platform including a surface and a first coupling element;
(b) a plurality of electrical elements under the surface;
(c) a processor coupled to the plurality of electrical elements; and
(d) a book on the surface, wherein the book comprises a spine having a second coupling element,
wherein the book and the platform are removably coupled through the first and second coupling elements.

2. The print media apparatus of claim 1 further comprising:
(e) a speaker coupled to the processor.

3. The print media apparatus of claim 1 further wherein the spine includes two second coupling elements at opposite ends of the spine, and wherein the platform includes two first coupling elements at opposite edges of the surface, wherein the book and the platform are detachably coupled together through corresponding first and second coupling elements.

4. The print media apparatus of claim 1 wherein the plurality of electrical elements comprise a plurality of pressure switches.

5. The print media apparatus of claim 1 wherein the book is a children's book.

6. The print media apparatus of claim 1 wherein the platform includes a first side including the surface, and a second side opposite the first side, and wherein the print media apparatus further comprises a cushion at the second side.

7. The print media apparatus of claim 1 wherein the book comprises a mode selection print element, and wherein selecting the mode selection print element one time causes the apparatus to be in a first mode, selecting the mode selection print element a second time causes the apparatus to be in a second mode, and selecting the mode selection print element a third time causes the apparatus to be in a third mode.

8. The print media apparatus of claim 1 wherein the first mode plays music when a print element in the book is selected, the second mode plays descriptive phrases when the print element in the book is selected, and the third mode plays rhymes when the print element in the book is selected.

9. The print media apparatus of claim 1 wherein the apparatus further comprises a handle coupled to the platform.

10. A print media apparatus comprising:
(a) a platform including a surface;
(b) a plurality of electrical elements under the surface;
(c) a processor coupled to the plurality of electrical elements; and
(d) a book on the surface, wherein the book comprises a mode selection print element, and wherein selecting the mode selection print element one time causes the apparatus to be in a first mode, selecting the mode selection print element a second time causes the apparatus to be in a second mode, and selecting the mode selection print element a third time causes the apparatus to be in a third mode.

11. The print media apparatus of claim 10 wherein the platform includes a first side including the surface, and a second side opposite the first side, and wherein the print media apparatus further comprises a cushion at the second side, and wherein the book and the platform are removably coupled through the first and second coupling elements.

12. The print media apparatus of claim 10 wherein the apparatus further comprises a handle coupled to the platform.

13. The print media apparatus of claim 10 wherein the first mode is designed for a first age range, and second mode is designed for a second age range, and the third mode is designed for a third age range.

14. The print media apparatus of claim 10 wherein the first mode plays music when a print element in the book is selected, the second mode plays descriptive phrases when the print element in the book is selected, and the third mode plays rhymes when the print element in the book is selected.

15. A method of using a print media apparatus comprising:
(a) providing a print media apparatus comprising (i) a platform including a surface and (ii) a book on the surface, wherein the book comprises a mode selection print element, and wherein selecting the mode selection print element one time causes the apparatus to be in a first mode, selecting the mode selection print element a second time causes the apparatus to be in a second mode, and selecting the mode selection print element a third time causes the apparatus to be in a third mode; and
(b) selecting the mode selection print element one time to cause the apparatus to be in the first mode, two times to cause the apparatus to be in the second mode, or three times to cause the apparatus to be in the third mode.

16. The method of claim 15 further comprising selecting a page identifier on a displayed page of the book to identify the displayed page of the book to the user.

17. The method of claim 15 wherein the first mode is designed for a first age range, and second mode is designed for a second age range, and the third mode is designed for a third age range.

18. The method of claim 15 further comprising:
(c) separating the book from the platform; and
(d) removably coupling a second book to the platform.

19. A kit comprising:
(a) a book comprising a spine and a plurality of pages comprising print elements, wherein the spine includes opposite ends comprising second coupling elements for coupling the book to a platform including corresponding first coupling elements; and
(b) a removable memory device comprising code for sounds associated with the print elements.

20. The kit of claim 19 wherein the book includes a children's book.

21. The kit of claim 19 wherein the book includes a mode selection print element, and wherein selecting the mode selection print element one time causes the apparatus to be in a first mode, selecting the mode selection print element a second time causes the apparatus to be in a second mode, and selecting the mode selection print element a third time causes the apparatus to be in a third mode.

22. The kit of claim 19 wherein the pages of the book comprise continuous polyethylene fibers.

23. The print media apparatus of claim 1 wherein pages of the book comprise continuous polyethylene fibers.

24. A print media apparatus comprising:
(a) a platform including a surface and a first coupling element;
(b) a plurality of electrical elements under the surface;
(c) a processor coupled to the plurality of electrical elements;
(d) a book on the surface, wherein the book comprises a spine;
(e) a first region of the surface proximate the spine of the book; and
(f) a second region of the surface distal to the spine of the book,
wherein the first region is more sensitive to user interaction than the second region.

25. The print media apparatus of claim 24 wherein the spine and the platform are removably coupled together.

26. The print media apparatus of claim 24 wherein the book is a children's book.

27. The print media apparatus of claim 24 further comprising a pillow under the platform.

28. The print media apparatus of claim 1 wherein the electrical elements are piezoelectric elements.

29. The print media apparatus of claim 10 wherein the electrical elements are piezoelectric elements.

28. The print media apparatus of claim 24 wherein the electrical elements are piezoelectric elements.

30. A print media apparatus comprising:
(a) a platform including a surface and a first coupling element;
(b) a plurality of electrical elements under the surface;
(c) a processor coupled to the plurality of electrical elements, wherein the electrical elements are piezoelectric elements; and
(d) a print medium on the surface.
